(19) United States
(12) Patent Application Publication
(10) Pub. No.: US 2018/0079693 A1
(43) Pub. Date: Mar. 22, 2018

(54) FERTILIZER CONTAINING AMMONIUM HYDROGEN CARBONATE

(71) Applicant: Heinz TISCHMACHER, Plankstadt (DE)

(72) Inventor: Heinz TISCHMACHER, Plankstadt (DE)

(21) Appl. No.: 15/565,511

(22) PCT Filed: Apr. 7, 2016
(86) PCT No.: PCT/EP2016/057612

§ 371 Date: Oct. 10, 2017

(30) Foreign Application Priority Data
Apr. 14, 2015 (DE) 10 2015 105 649.6

(51) Int. Cl. C05C 3/00; C05B 17/00; C05G 3/04; C05G 3/00

(52) U.S. Cl. CPC C05C 3/00; C05G 3/0052; C05G 3/04; C05B 17/00

(57) ABSTRACT

A fertilizer includes ammonium hydrogen carbonate (ABC) as the main component and contains at least one additive from the group including biochar, non-oxidizing inorganic salt, compacting agents, bentonite, oxidizing agent and cellulose derivative. The biochar may be impregnated with an inorganic acid. The cellulose derivative may be a cellulose ether. The oxidizing agent may be a peroxide or permanganate. The compacting agent may be TiO₂, gelatin and/or liqnin sulfonic acid.

The invention relates to a fertilizer containing ammonium hydrogen carbonate as well as at least one additive for binding the NH₃ and the CO₂ components of ABC in the solid and/or in the dissolved state.

Nitrogen-containing fertilizers are among the most important fertilizer forms, since nitrogen is essential for the plant growth. In this process, plants are able to take up the nitrogen directly as nitrate, ammonium and urea. In principle, a distinction is made between inorganid and organic nitrogen fertilizers.

One fertilizer in which ammonium is supplied directly to the plants is ammonium hydrogen carbonate (also known as: ammonium bicarbonate=ABC). Heretofore, however, this fertilizer has been manufactured and also used in large quantities only in China. What is problematic for ammonium hydrogen carbonate is that this compound already decomposes completely at 60° C. and above, and so ammonium hydrogen carbonate is usually stored at 15° C. in closed rooms, in order to prevent decomposition of the compound.

The use of this fertilizer is described in CN 1053225 A. In this connection, at least one additive is added to the ammonium hydrogen carbonate. If dicyanamide is used as the additive, this additive acts both as a nitrate reductase inhibitor and as a crosslinking agent. Since the additive is also a crosslinking agent, the fertilizer can be stored for a longer duration, because the ammonium hydrogen carbonate does not decompose as rapidly.

However, the additives described in CN 1053225 A are not very easy to manufacture and are toxic or at least harmful to health.

The task of the present invention is therefore to provide a fertilizer that contains ammonium hydrogen carbonate as well as at least one additive, wherein the additive can be obtained inexpensively and is nontoxic.

This task is accomplished according to the features of claim 1.

[A1] Thus the invention relates to a fertilizer containing NH₄HCO₃ (ABC), wherein at least one substance from the group comprising biochar, nonoxidizing inorganic salts, compacting agents, bentonite, oxidizing agents and cellulose derivatives is added as additive to the fertilizer.

Biochar improves in particular the storage properties of the fertilizer, because biochar acts as an absorber for CO₂, H₂O and NH₃ if the ammonium hydrogen carbonate (ABC) decomposes. In addition, the biochar improves the soil properties. Preferably, biochar is added in a proportion of 5-10 percent by weight.

In addition, the storage properties of the fertilizer can be improved by addition of at least one cellulose derivative in a proportion of 1-10 percent by weight, preferably 3-7 per cent by weight. Nonoxidizing inorganic salts, such as nonoxidizing magnesium salts, for example, may also be admixed with the fertilizer in proportions of 5-20 percent by weight. Examples of suitable magnesium salts are olivine, Mg₃(PO₄)₂ and/or Mg₂SiO₄. By addition of this salt, the CO₂ of the ABC is bound in the form of MgCO₃ or Mg(HCO₃)₂. If Mg₃(PO₄)₂ is admixed as the nonoxidizing magnesium salt, both carbon dioxide and ammonia are bound in the soil. Instead of a magnesium salt, at least one calcium salt, for example CaCO₃, Ca(HCO₃)₂ and/or Ca₃(PO₄)₂, may also be used.

By addition of bentonite, the loss of ammonia is greatly reduced. Preferably, the fertilizer contains bentonite in a proportion of 5-20 percent by weight.

Usually the fertilizer is pressed to compacted products, for example to pellets. In this connection, the compacting agent acts to increase the stability of the fertilizer.

[A2] Preferably, the biochar is impregnated with an inorganic acid. If this biochar is impregnated with an inorganic acid, the fertilizer can be used with this biochar in basic soils in particular. Furthermore, this has the advantage that the acid binds NH₃ as NH₄⁺, whereby NH₃ cannot escape by outgassing.

[A3] Advantageously, this inorganic acid is H₃PO₄ and/or H₂SO₄, because the anions of these acids represent important plant nutrients.

[A04] The cellulose derivative is preferably a cellulose ether, because cellulose ethers are readily available and inexpensive.

[A05] Preferably, the cellulose derivative is a potassium compound of carboxymethyl cellulose, because potassium is an important nutrient element for plants.

[A06] Since N₂O is formed during denitrification and is able to escape from the soil, denitrification represents one of the main causes of nitrogen loss in the soil. Therefore at least one oxidizing agent is admixed with the fertilizer.

[A07] Preferably, peroxide compounds are used as the oxidizing agent, because peroxide compounds are good oxidizing agents. Alkaline earth peroxides are particularly preferred, since they are quite inexpensive.

[A08] Preferably MgO₂ and/or CaO₂ are used as the alkaline earth peroxide, since the Ca²⁺ or the Mg²⁺ cations also represent important plant nutrients.

[A09] In a further preferred embodiment, permanganates, especially KMnO₄, are used as oxidizing agents. Permanganates have the advantage that they are nontoxic but nevertheless have a sufficiently high oxidizing ability.

[A10] In another preferred embodiment, the compacting agent is gelatin, TiO₂ and/or lignin sulfonic acid. The stability of the fertilizer is significantly increased by addition of this compacting agent. Preferably, the proportion by weight w of compacting agent is w=1-21. Preferably, the proportions by weight of lignin sulfonic acid and also of TiO₂ are 3-6, in which case the fertilizer has particularly high stability when the proportion by weight of lignin sulfonic acid is approximately 5. In this case the gelatin may be added in liquid form or as powder. If liquid gelatin is used, the fertilizer must also be subsequently dried.

[All] Preferably, the nonoxidizing inorganic salt is a calcium salt and/or a magnesium salt or a mixture of various magnesium salts and/or calcium salts. Examples of suitable magnesium salts are olivine, Mg₂SiO₄ and/or Mg₃(PO₄)₂. As examples, Ca₂SiO₄ and/or Ca₃(PO₄)₂ may be used as the calcium salt.

These compounds are quite inexpensive and are capable of binding CO₂ and NH₃.

The invention will be explained in more detail hereinafter on the basis of exemplary embodiments.

As the main component, the fertilizer contains ammonium hydrogen carbonate (ABC=NH₄HCO₃). To ensure that the NH₄HCO₃ present in the fertilizer can be stored for a longer period—even at higher temperatures—the NH₄HCO₃ may contain biochar, for example, as additive. If the NH₄HCO₃ were to decompose into the individual components CO₂, H₂O and NH₃, therefore, the biochar would function as an absorber for CO₂, H₂O and NH₃. In this case it is advantageous for the biochar to have a very high specific internal surface, because thereby a very high load can be achieved. The use of biochar therefore prevents NH₃ and CO₂ from being released into the atmosphere if.they are formed as decomposition products. It is further advantageous with biochar that the soil properties can be significantly improved. For example, biochar reduces the population of denitrifying bacteria and thus the formation of N₂O.

Preferably, the biochar is impregnated with an inorganic acid, so that the pH in the environment of the plants is 7.2, and so NH₃ is present mainly as NH₄⁺ and CO₂ as HCO₃. At pH=7.2, therefore, CO₂ and NH₃ are prevented from escaping as gases and thus being removed from the system, i.e. the soil. If the biochar is impregnated with an inorganic acid, this biochar may be used in basic soils in particular. Advantageously, this inorganic acid is H₃PO₄ and/or H₂SO₄, because the anions of these acids also represent important plant nutrients. If the biochar is impregnated with H₂SO₄, for example, NH₃ reacts to form NH₃HSO₄ or (NH₃)₂SO₄.

For better storage capability, at least one cellulose derivative may be added as additive to the fertilizer. ABC is coated by the cellulose derivative, in which case the hydrophobic groups of the cellulose derivative shield ABC, to the effect that ABC cannot hydrolyze. This at least one cellulose derivative may be contained in the fertilizer in addition to the biochar. Preferably cellulose ethers are used as the cellulose derivative, becauSe these cellulose ethers are readily available and inexpensive. Preferably, the cellulose derivative is a potassium compound of carboxymethyl cellulose, because carboxymethyl cellulose is a common cellulose derivative and because potassium is an important nutrient for plants.

Thus both biochar and cellulose derivatives function to improve the storage capability of the ammonium hydrogen carbonate.

In order to counter the problem that NH₄HCO₃ dissolves very rapidly in the moist soil and therefore this is not available to the plants, the fertilizer additionally contains additives that bind the NH₃ and the CO₂ components of NH₄HCO₃ in the soil. If NH₄HCO₃ is introduced into the soil, the presence of humic acids and water in the soil leads to the following chemical equilibrium, wherein both the humic acids and also water in the soil protonate dissolved NH₃ to NH₄⁺.

NH₄⁺+HCO₃⁻+H⁺⇄NH₄⁺+CO₂+H₂O

As a result of this equilibrium, CO₂ is formed precisely in acid soils and is able to escape from the soil as gas.

If a nonoxidizing magnesium salt such as Mg₃(PO₄)₂, for example, is used now as additive, both the carbon dioxide and the ammonia are bound in the soil.

Mg₃(PO₄)₂ is present in aqueous solution both as Mg₂⁺ and as PO₄³⁻. Under these conditions, NH₄⁺ in aqueous solution is precipitated as MgNH₄PO₄.6H₂O.

Mg₂⁺+NH₄⁺+PO₄³⁻+6 H₂O->MgNH₄PO₄.6H₂O

In the presence of an acid, for example humic acid, MgNH₄PO₄.6H₂O dissolves slowly once again. Thus MgNH₄PO₄.6H₂O functions as a reservoir for NH₄⁺. Instead of Mg₃(PO₄)₂, however, any other magnesium salt may be used in conjunction with a phosphate-containing salt. For example, a mixture of MgO and KH₂PO₄ may be used to bind NH₄⁺ or NH₃ in the form of MgNH₄PO₄.6H₂O.

Furthermore, HCO₃⁻ or CO₂ can'be scavenged by the Mg₂⁺ ions of a magnesium salt. In the process, Mg(HCO₃)₂ can also be formed besides MgCO₃. The use of magnesium compounds therefore prevents CO₂ from being released into the atmosphere and acting as greenhouse gas.

It is also possible, however, to scavenge the HCO₃⁻ or CO₂ present in solution by magnesium compounds, such as olivine or Mg₂SiO₄, for example, or a mixture of olivine and Mg₂SiO₄. Advantageously, olivine and/or Mg₂SiO₄ should be present as finely ground powder, in order to present an active surface that is as large as possible. This powder may be mixed with ABC, for example, and pressed to a granulated fertilizer (compacted product). It is also conceivable, however, for ABC to exist in the form of pressed fertilizer granules and for olivine and/or Mg₂SiO₄ to coat the fertilizer granules.

Thus it is clear to the person skilled in the art that nonoxidizing magnesium salts such as olivine and/or Mg₂SiO₄ may also be used in conjunction with a phosphate-containing salt, such as K₂HPO₄ or K₃PO₄, for example, instead of Mg₃(PO₄)₂, wherewith both CO₂ and also NH₃ can be bound.

It will be understood that a calcium salt may also be used instead of a magnesium salt to scavenge CO₂. For this purpose, calcium phosphate in particular or a mixture of calcium phosphate and magnesium phosphate may be considered as additive. In this connection, ABC may be coated by calcium phosphate or magnesium phosphate, especially when ABC exists as pressed granulated fertilizer.

The loss of ammonia can also be greatly reduced by addition of bentonite. Thus it has been possible to lower the losses of ammonia from ABC from approximately 62% to 34% by addition of air-dried bentonite and even to 15% by addition of water-saturated bentonite.

It is further advantageous when the fertilizer additionally contains at least one oxidizing agent. The proportion by weight w of the at least one oxidizing agent is w=1-10, in which case preferably at most 10 percent by weight of oxidizing agent is added. These oxidizing agents are preferably peroxides and particularly preferably alkaline earth peroxides, since alkaline earth metals can be produced fairly easily. This at least one oxidizing agent counters a reduction of nitrate, i.e. a denitrification.

MgO₂ and/or CaO₂ are particularly preferred, since the Ca²⁺ or the Mg²⁺ cations represent important plant nutrients. Permanganates, preferably KMnO₄, are also preferred, because permanganates represent good oxidizing agents, which are nontoxic and easy to handle.

These oxidizing agents may also be used for nitrification. Whether the oxidizing agents, for example peroxides or permanganates, are used for denitrification or for nitrification, depends on their concentration and on the soil (for example, on the pH of the soil), into which the fertilizer is to be introduced.

Dicyandiamide, for example, may also be used as nitrification inhibitor.

The fertilizer may indeed be powder-like, but preferably it exists in the form of compacted products. If the fertilizer exists in the form of compacted products, these preferably have the form of pellets. Compared with powder-like fertilizers, compacted products have the advantage that dust generation does not occur during application of the fertilizer. In this connection it has proved to be particularly advantageous when the fertilizer is introduced approximately 4 to 8 cm, preferably approximately 6 cm under the surface of the ground, because then it exhibits particularly high efficiency.

The fertilizer is particularly stable when it exists in the form, of compacted products and contains compacting agent in a proportion by weight w of w=1-21. Gelatin, TiO₂ and/or lignin sulfonic acid are suitable as compacting agent. Preferably, the .proportions by weight of lignin sulfonic acid and also of TiO₂ are w=3-6. The fertilizer then has particularly high stability when the lignin sulfonic acid has a proportion by weight of approximately 5. In this case the gelatin may be added to the fertilizer in liquid form or as powder. If gelatin solution is used, the fertilizer must also be subsequently dried. Preferably, the fertilizer contains gelatin solution in a proportion of 15-21 percent by weight or gelatin powder in a proportion of 1-10 percent by weight.

Some variants of the fertilizer containing ABC and at least one additive are presented in the following tables.

Proportion by weight w of the additive

| | | | | | | Lignin | Mag- |
|---|---|---|---|---|---|---|---|
| Var- | | Bio- | Gelatin | Gelatin | | sulfonic | nesium |
| iant | Bentonite | char | (powder) | (solution) | TiO₂ | acid | salts |
| 1 | 5 | | 2 | | | | |
| 2 | 10 | | 2 | | | | |
| 3 | 10 | | 2 | | | | |
| 4 | 5 | | 7 | | | | |
| 5 | 5 | | | | | 5 | |
| 6 | 10 | | 7 | | | | |
| 7 | 10 | | | | | 5 | |
| 8 | 20 | | 7 | | | | |
| 9 | 5 | | | 21 | | | |
| 10 | 5 | | | | 5 | | |
| 11 | 5 | | | 17 | 4 | | |
| 12 | 10 | | | 20 | 4 | | |
| 13 | 20 | | | 16 | 4 | | |
| 14 | 10 | | | | | 5 | |
| 15 | | 5 | | | | 5 | |
| 16 | | 5 | 7 | | | | |
| 17 | | 10 | | | | 5 | |
| 18 | | 10 | 7 | | | | |
| 19 | | 20 | | | | | |
| 20 | | | | | | 5 | 5 |
| 21 | | | | | | 5 | 10 |
| 23 | | | | | | 5 | 20 |
| 24 | | | | | | | 5 |
| 25 | | | | | | | 10 |
| 26 | | | | | | | 20 |

The proportion by weight w of the additives always relates to the total weight of the fertilizer, wherein the rest is ABC. The variant 24 would therefore contain 5 percent by weight of magnesium salts and 95 percent by weight of ABC. It will be understood that the variants listed above may additionally also contain an oxidizing agent, cellulose derivatives and/or calcium salts. In this connection, the variants 5, 7, 16 and 21, which contain lignin sulfonic acid, are particularly stable.

1. Fertilizer containing ammonium hydrogen carbonate (ABC) as well as at least one additive for binding the NH₃ and the CO₂ components of ABC in the solid and/or in the dissolved state, wherein the fertilizer contains at least one substance from the group comprising biochar, compacting agents, oxidizing agents and cellulose derivatives as additive.

2. Fertilizer according to claim 1, wherein the biochar is impregnated with an inorganic acid.

3. Fertilizer according to claim 2, wherein the inorganic acid is H₃PO₄ and/or H₂SO₄.

4. Fertilizer according to claim 1, wherein the cellulose derivative is a cellulose ether.

5. Fertilizer according to claim 4, wherein the cellulose ether is a potassium compound of carboxymethyl cellulose.

6. Fertilizer according to claim 1, wherein the oxidizing agent is a peroxide.

7. Fertilizer according to claim 6, wherein the peroxide is an alkaline earth peroxide.

8. Fertilizer according to claim 7, wherein the alkaline earth peroxide is MgO₂ and/or CaO₂.

9. Fertilizer according to claim 1, wherein the oxidizing agent is permanganate.

10. Fertilizer according to claim 1, wherein the compacting agent is TiO₇, gelatin and/or lignin sulfonic acid.

11. (canceled)
